(19) United States
(12) Patent Application Publication
(10) Pub. No.: US 2019/0193472 A1
(43) Pub. Date: Jun. 27, 2019

(54) PNEUMATIC TIRE

(71) Applicant: TOYO TIRE & RUBBER CO., LTD., Itami-shi (JP)

(72) Inventor: Naoya Kubo, Itami-shi (JP)

(73) Assignee: TOYO TIRE & RUBBER CO., LTD., Itami-shi (JP)

(21) Appl. No.: 16/211,639

(22) Filed: Dec. 6, 2018

(30) Foreign Application Priority Data
Dec. 21, 2017 (JP) 2017-244935

(51) Int. Cl. B60C 11/12; B60C 11/04

(52) U.S. Cl. CPC B60C 11/1218; B60C 11/1236; B60C 11/1272; B60C 2011/0341; B60C 2011/1209; B60C 2011/1227; B60C 2011/1245; B60C 11/042

(57) ABSTRACT

In a pneumatic tire, a rubber surface layer portion comprises a first rubber portion formed from a first rubber, and a second rubber portion formed from a second rubber having a rubber hardness greater than a rubber hardness of the first rubber, the first rubber portion is arranged at a first side in a tire width direction, the second rubber portion is arranged at a second side in the tire width direction, an interface between the first rubber portion and the second rubber portion is arranged between a pair of main grooves that are arranged in outwardmost fashion in the tire width direction, and an average tire outside diameter toward the second side in the tire width direction from a tire equatorial plane is greater than an average tire outside diameter toward the first side in the tire width direction from the tire equatorial plane.

### CROSS REFERENCE TO RELATED APPLICATIONS

This application claims the benefit of priority of Japanese application no. 2017-244935, filed on Dec. 21, 2017, which is incorporated herein by reference.

### BACKGROUND OF THE INVENTION

### Field of the Invention

The present invention relates to a pneumatic tire.

### Description of the Related Art

Conventionally a pneumatic tire might, for example, be provided with a rubber surface layer portion having an outer surface in the tire radial direction, wherein a first side and a second side in the tire width direction of the rubber surface layer portion are formed from rubber of respectively different rubber hardnesses (e.g., JP 2012-76593 A). With such a pneumatic tire, because there will be a difference in contact patch length at the first side versus the second side in the tire width direction when driving straight ahead, there may, for example, be increase in the amount of conicity (force acting in the tire width direction) that occurs when driving straight ahead.

### SUMMARY OF THE INVENTION

The problem is therefore to provide a pneumatic tire that will make it possible to suppress occurrence of difference in contact patch length at a first side versus a second side in the tire width direction when driving straight ahead.

There is provided a pneumatic tire including a plurality of main grooves extending in a tire circumferential direction, the pneumatic tire includes:
a rubber surface layer portion having an outer surface in a tire radial direction;
the rubber surface layer portion comprises a first rubber portion formed from a first rubber, and a second rubber portion formed from a second rubber having a rubber hardness greater than a rubber hardness of the first rubber;
the first rubber portion is arranged at a first side in a tire width direction;
the second rubber portion is arranged at a second side in the tire width direction;
an interface between the first rubber portion and the second rubber portion is arranged between a pair of main grooves that are arranged in outwardmost fashion in the tire width direction; and
an average tire outside diameter toward the second side in the tire width direction from a tire equatorial plane is greater than an average tire outside diameter toward the first side in the tire width direction from the tire equatorial plane.

Further, the pneumatic tire may further include:
a plurality of land portions that are partitioned by contact patch ends and the plurality of main grooves;
wherein the plurality of land portions include a shoulder land portion that is arranged toward the second side in the tire width direction from the tire equatorial plane and that is arranged in outwardmost fashion at the second side in the tire width direction, and a middle land portion that is arranged toward the second side in the tire width direction from the tire equatorial plane and that is arranged in next-to-outwardmost fashion at the second side in the tire width direction; and
an average tire outside diameter difference between locations mutually separated by identical amounts in the tire width direction from the tire equatorial plane at the shoulder land portion is greater than an average tire outside diameter difference between locations mutually separated by identical amounts in the tire width direction from the tire equatorial plane at the middle land portion.

Further, the pneumatic tire may further include:
a plurality of land portions that are partitioned by contact patch ends and the plurality of main grooves;
wherein the plurality of land portions include a shoulder land portion that is arranged toward the second side in the tire width direction from the tire equatorial plane and that is arranged, in outwardmost fashion at the second side in the tire width direction, and a middle land port on that is arranged toward the second side in the tire width direction from the tire equatorial plane and that is arranged in next-to-outwardmost fashion at the second side in the tire width direction; and
a maximum tire outside diameter difference between locations mutually separated by identical amounts in the tire width direction from the tire equatorial plane at the shoulder land portion is greater than a maximum tire outside diameter difference between locations mutually separated by identical amounts in the tire width direction from the tire equatorial plane at the middle land portion.

Further, the pneumatic tire may further include:
an indicator region that indicates a vehicle mounting direction;
wherein the second rubber portion is arranged toward the exterior when the tire is mounted on the vehicle.

Further, the pneumatic tire may further include:
a plurality of land portions that are partitioned by contact patch ends and the plurality of main grooves;
wherein a void fraction of those among the land portions that are made up of the first rubber portion is less than a void fraction of those among the land portions that are made up of the second rubber portion.

Further, the pneumatic tire may further include:
a center land portion that is partitioned by the plurality of main grooves, the center land portion that contains the tire equatorial plane;
wherein the interface is located at the center land portion.

Further, the pneumatic tire may further include:
a plurality of land portions that are partitioned by contact patch ends and the plurality of main grooves;
wherein the plurality of land portions include a first shoulder land portion that is arranged in outwardmost fashion at the first side in the tire width direction, and a second shoulder land portion that is arranged in outwardmost fashion at the second side in the tire width direction;
the respective first and second shoulder land portions are provided with a plurality of width grooves of groove width not less than 1.6 mm, the width grooves extend so as to intersect the tire circumferential direction; and
pitch between the width grooves at the first shoulder land portion is greater than pitch between the width grooves at the second shoulder land portion.

Further, the pneumatic tire may further include:
a plurality of land portions that are partitioned by contact patch ends and the plurality of main grooves;
wherein the plurality of land portions include a shoulder land portion that is arranged in outwardmost fashion at the second side in the tire width direction;
the shoulder land portion is provided with a protrusion that protrudes toward the exterior in the tire radial direction from a profile surface;
the shoulder land portion is uniformly partitioned in the tire width direction into three regions including a central region; and
a peak of the protrusion is arranged at the central region.

Further, the pneumatic tire may further include:
a plurality of land portions that are partitioned by contact patch ends and the plurality of main grooves;
wherein the plurality of land portions include a shoulder land portion that is arranged in outwardmost fashion at the second side in the tire width direction;
the shoulder land portion is provided with a protrusion that protrudes toward the exterior in the tire radial direction from a profile surface;
the shoulder land portion is uniformly partitioned in the tire width direction into three regions; and
a peak of the protrusion is arranged at that region among the three regions which is most toward the second side in the tire width direction.

### BRIEF DESCRIPTION OF DRAWINGS

FIG. 1 is a view of a section, taken along a tire meridional plane, of the principal components in a pneumatic tire associated with an embodiment;

FIG. 2 is a drawing showing a tread surface of a pneumatic tire associated with same embodiment as they would exist if unwrapped so as to lie in a single plane;

FIG. 3 is an enlarged view of region III in FIG. 1;

FIG. 4 is a schematic cross-sectional view, taken along a tire meridional plane, of the principal components in a pneumatic tire associated with same embodiment;

FIG. 5 is an enlarged view of region V in FIG. 4;

FIG. 6 is an enlarged view of region VI in FIG. 4;

FIG. 7 is a drawing showing the surface shape that comes in contact with the road surface at a pneumatic tire associated with a comparative example;

FIG. 8 is a drawing showing the surface shape that comes in contact with the road surface at a pneumatic tire associated with FIG. 1 through FIG. 6;

FIG. 9 is a view of a section, taken along a tire meridional plane, of the principal components in a pneumatic tire associated with another embodiment; and

FIG. 10 is a view of a section, taken along a tire meridional plane, of the principal components in a pneumatic tire associated with yet another embodiment.

### DETAILED DESCRIPTION OF THE INVENTION

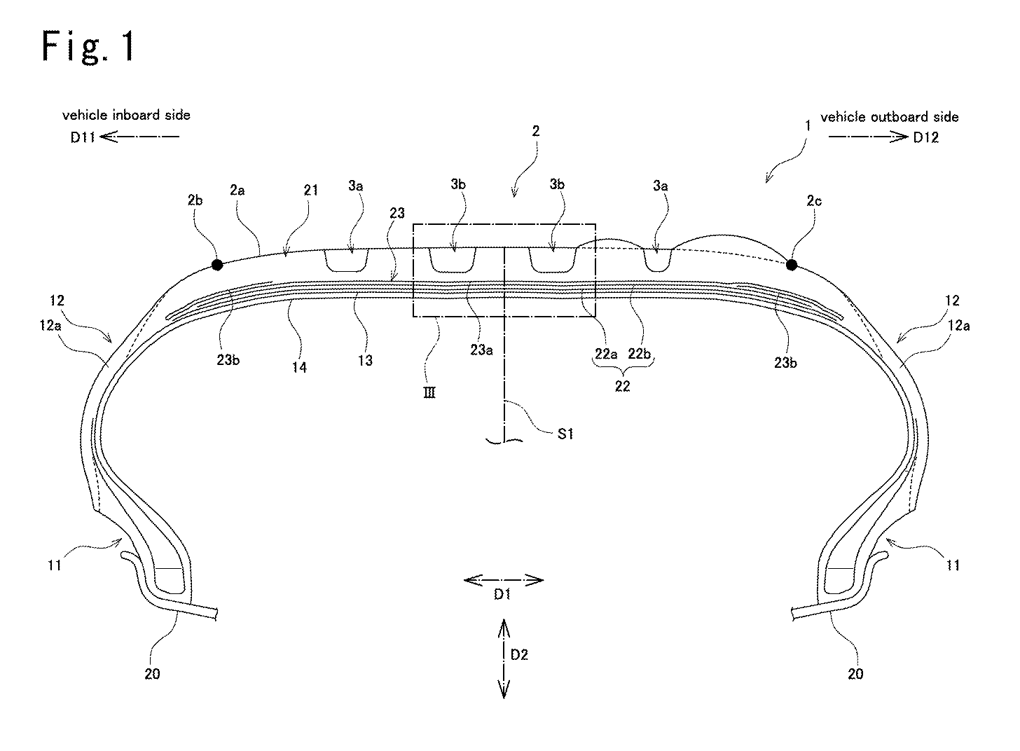

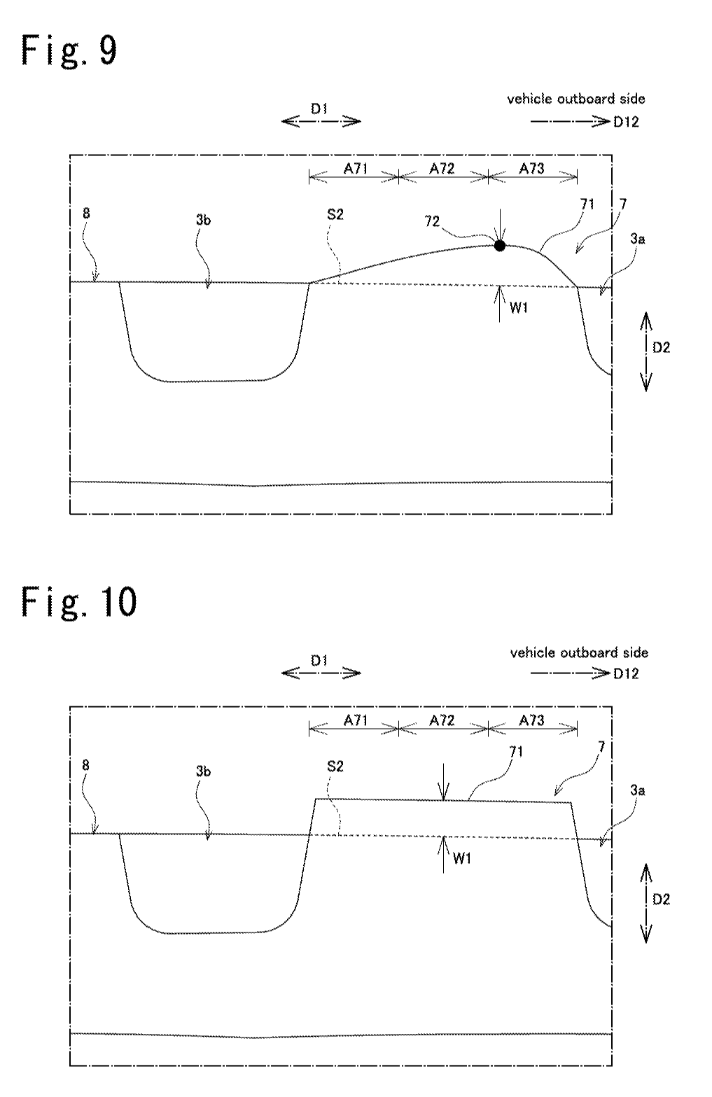

Below, an embodiment of a pneumatic tire is described with reference to FIG. 1 through FIG. 8. At the respective drawings (and the same is true for FIG. 9 and FIG. 10), note that dimensional ratios at the drawings and actual dimensional ratios are not necessarily consistent, and note further that dimensional ratios are not necessarily consistent from drawing to drawing.

At the respective drawings, first direction D1 is the tire width direction D1 which is parallel to the tire rotational axis which is the center of rotation of pneumatic tire (hereinafter also referred to as simply “tire”) 1, second direction D2 is the tire radial direction D2 which is the direction of the diameter of tire 1, and third direction D3 is the tire circumferential direction D3 which is circumferential with respect to the rotational axis of the tire. Note that the tire width direction D1 may be further subdivided into first side D11, which is also referred to as first width direction side D11; and second side D12, which is also referred to as second width direction side D12.

Tire equatorial plane S1 refers to a plane that is located centrally in the tire width direction D1 of tire 1 and that is perpendicular to the rotational axis of the tire; tire meridional planes refer to planes that are perpendicular to tire equatorial plane S1 and that contain the rotational axis of the tire. Furthermore, the tire equator is the curve formed by the intersection of tire equatorial plane S1 and the outer surface (tread surface 2a, described below) in the tire radial direction D2 of tire 1.

As shown in FIG. 1, tire 1 associated with the present embodiment is provided with a pair of bead regions 11 at which beads are present; sidewall regions 12 which extend outwardly in the tire radial direction D2 from the respective bead regions 11; and tread region 2, the exterior surface in the tire radial direction D2 of which contacts the road surface and which is contiguous with the outer ends in the tire radial direction D2 of the pair of sidewall regions 12. In accordance with the present embodiment, tire 1 is a pneumatic tire 1, the interior of which is capable of being filled with air, and which is capable of being mounted on a rim 20.

Furthermore, tire 1 is provided with carcass layer 13 which spans the pair of beads, and inner liner layer 14 which is arranged at a location toward the interior from carcass layer 13 and which has superior functionality in terms of its ability to impede passage of gas therethrough so as to permit air pressure to be maintained. Carcass layer 13 and inner liner layer 14 are arranged in parallel fashion with respect to the inner circumferential surface of the tire over a portion thereof that encompasses bead regions 11, sidewall regions 12, and tread region 2.

Tread region 2 is provided with tread rubber 21 having tread surface 2a which contacts the road surface, and belt region 22 which is arranged between tread rubber 21 and carcass layer 13. Furthermore, to reinforce belt region 22, tread region 2 is provided with belt reinforcing region 23 which is arranged between tread rubber 21 and belt region 22.

Present at tread surface 2a is the contact patch that actually comes in contact with the road surface, and the portions within said contact patch that are present at the outer ends in the tire width direction D1 are referred to as contact patch ends 2b, 2c. Note that said contact patch refers to the portion of the tread surface 2a that comes in contact with the road surface when a normal load is applied to a tire 1 mounted on a normal rim 20 when the tire 1 is inflated to normal internal pressure and is placed in vertical orientation on a flat road surface. Furthermore, of the ends 2b, 2c of the contact patch, the end 2b on the first width direction side D11 of the contact patch is referred to as the first contact patch end 2b; and the end 2c on the second width direction side D12 of the contact patch is referred to as the second contact patch end 2c.

Normal rim 20 is that particular rim 20 which is specified for use with a particular tire 1 in the context of the body of standards that contains the standard that applies to the tire 1 in question, this being referred to, for example, as a standard rim in the case of JATMA, a “Design Rim” in the case of TRA, or a “Measuring rim” in the case of ETRTO.

Normal internal pressure is that air pressure which is specified for use with a particular tire 1 in the context of the body of standards that contains the standard that applies to the tire 1 in question, this being maximum air pressure in the case of JATMA, the maximum value listed at the table entitled “TIRE LOAD LIMITS AT VARIOUS COLD INFLATION PRESSURES” in the case of TRA, or “INFLATION PRESSURE” in the case of ETRTO, which when tire 1 is to used on a passenger vehicle is taken to be an internal pressure of 180 KPa.

Normal load is that load which is specified for use with a particular tire 1 in the context of the body of standards that contains the standard that applies to the tire 1 in question, this being maximum load capacity in the case of JATMA, the maximum value listed at the aforementioned table in the case of TRA, or “LOAD CAPACITY” in the case of ETRTO, which when tire 1 is to be used on a passenger vehicle is taken to be 85% of the load corresponding to an internal pressure of 180 KPa.

Belt region 22 is provided with at least one (two in the present embodiment) belt layer(s) 22a, 22b. More specifically, belt region 22 is provided with first belt layer 22a, and with second belt layer 22b which is arranged toward the exterior in the tire radial direction D2 from first belt layer 22a. Note that there is no particular limitation with respect to the number of layer(s) at belt layer(s) 22a, 22b.

Belt reinforcing region 23 is provided with cap reinforcing layer(s) 23a which are arranged so as to cover belt layer(s) 22a, 22b at all locations therealong in the tire width direction D1. Furthermore, belt reinforcing region 23 is provided with edge reinforcing layer(s) 23b, 23b which are arranged so as to cover the ends of belt layer(s) 22a, 22b in the tire width direction D1.

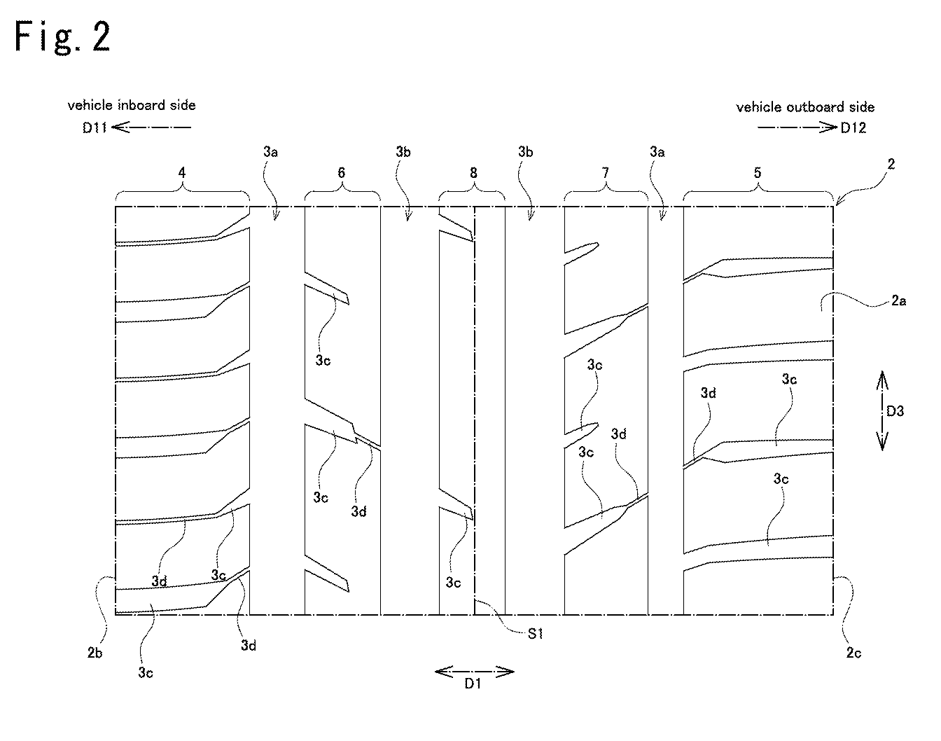

As shown in FIG. 1 and FIG. 2, tread rubber 21 is provided with a plurality of main grooves 3a, 3b extending in the tire circumferential direction D3. Main groove 3a, 3b extends continuously in the tire circumferential direction D3. Note that whereas main grooves 3a, 3b extend in straight fashion in the tire circumferential direction D3 in the present embodiment, there is no limitation with respect to such constitution, it also being possible to adopt a constitution in which these are, for example, repeatedly bent such that they extend in zigzag fashion, or a constitution in which these are, for example, repeatedly curved such that they extend in wavy fashion.

Main groove 3a, 3b might, for example, be provided with so-called tread wear indicator(s) (not shown) which are portions at which depth of the groove is reduced so as to make it possible to ascertain the extent to which wear has occurred as a result of the exposure thereof that takes place in accompaniment to wear. Furthermore, main groove 3a, 3b might, for example, have a width that is not less than 3% of the distance (dimension in the tire width direction D1) between contact patch ends 2b, 2c. Furthermore, main groove 3a, 3b might, for example, have a width that is not less than 5 mm.

Furthermore, at the plurality of main grooves 3a, 3b, the pair of main grooves 3a, 3a arranged at outermost locations in the tire width direction D1 are referred to as shoulder main grooves 3a, and the main groove(s) 3b arranged between the pair of shoulder main grooves 3a, 3a are referred to as center main groove(s) 3b. Note that whereas in the present embodiment the number of center main groove(s) 3b that are present is two, there is no limitation with respect to such constitution, it also being possible, for example, for there to be one thereof, or three or more thereof.

Tread rubber 21 is provided with a plurality of land portions 4 through 8 which are partitioned by main grooves 3a, 3b and contact patch ends 2b, 2c. At the plurality of land portions 4 through 8, land portion(s) 4, 5 which are partitioned by shoulder main groove(s) 3a and contact patch ends 2b, 2c are referred to as shoulder land portion(s) 4, 5, and land portion(s) 6 through 8 which are partitioned by respective main grooves 3a, 3b adjacent thereto and which are arranged between the pair of shoulder land portion(s) 4, 5 are referred to as middle land portion(s) 6 through 8.

At middle land portion(s) 6 through 8, land portion(s) 6, 7 which are partitioned by shoulder main groove(s) 3a and center main groove(s) 3b are referred to as mediate land portion(s) 6, 7, and land portion(s) 8 which are partitioned by respective center main groove(s) 3b, 3b are referred to as center land portion(s) 8. Note that the shoulder land portion 4 at the first width direction side D11 are referred to as first shoulder land portion 4, the shoulder land port ion 5 at the second width direction side D12 are referred to as second shoulder land portion 5, the mediate land portion 6 at the first width direction side D11 are referred to as first mediate land portion 6, and the mediate land portion 7 at the second width direction side D12 are referred to as second mediate land portion 7.

In accordance with the present embodiment, center main groove(s) 3b, 3b are arranged so as to straddle tire equatorial plane S1. This being the case, center land portion 8 are arranged in such fashion as to contain tire equatorial plane S1. As a result, the entirety of first shoulder land portion 4 and of first mediate land portion 6 are arranged to the first width direction side D11 of tire equatorial plane S1, and the entirety of second shoulder land portion 5 and of second mediate land portion 7 are arranged to the second width direction side D12 of tire equatorial plane S1.

Furthermore, land portions 4 through 8 are provided with a plurality of land grooves 3c, 3d. The plurality of land grooves 3c, 3d extend so as to intersect the tire circumferential direction D3. In addition, of the land grooves 3c, 3d that extend so as to intersect the tire circumferential direction D3, land groove(s) 3c of groove width not less than 1.6 mm are referred to as width groove(s) 3c, and land groove(s) 3d of groove width less than 1.6 mm are referred to as sipe(s) 3d. Note, moreover, that land portions 4 through 8 may be provided with land groove(s) that extend in continuous or intermittent fashion in the tire circumferential direction D3 and that are of groove width(s) less than the groove width(s) of main grooves 3a, 3b, such land groove(s) being referred to as circumferential groove(s).

Tire 1 has a structure that is asymmetric with respect to tire equatorial plane S1. In accordance with the present embodiment, tire 1 is a tire for which a vehicle mounting direction is indicated, which is to say that there is an indication of whether the left or the right side of the tire should be made to face the vehicle when tire 1 mounted on rim 20. Moreover, the tread pattern formed at the tread surface 2a at tread region 2 is asymmetric with respect to tire equatorial plane S1.

The orientation in which the tire is to be mounted on the vehicle is indicated at sidewall region 12. More specifically, sidewall region 12 is provided with sidewall rubber 12a which is arranged toward the exterior in the tire width direction D1 from carcass layer 13 so as to constitute the tire exterior surface, the surface of said sidewall rubber 12a having an indicator region.

For example, one sidewall region 12, i.e., that which is to be arranged toward the inboard side (left side at the drawings; hereinafter also referred to as “vehicle inboard side”) of the mounted tire, is marked (e.g., with the word “INSIDE” or the like) so as to contain an indication to the effect that it is for the vehicle inboard side. While for example, the other sidewall region 12, i.e., that which is to be arranged toward the outboard side (right side at the drawings; hereinafter also referred to as “vehicle outboard side”) of the mounted tire, is marked (e.g., with the word “OUTSIDE” or the like) so as to contain an indication to the effect that it is for the vehicle outboard side. In accordance with the present embodiment, first width direction side D11 is taken to be the vehicle inboard side, and second width direction side D12 is taken to be the vehicle outboard side.

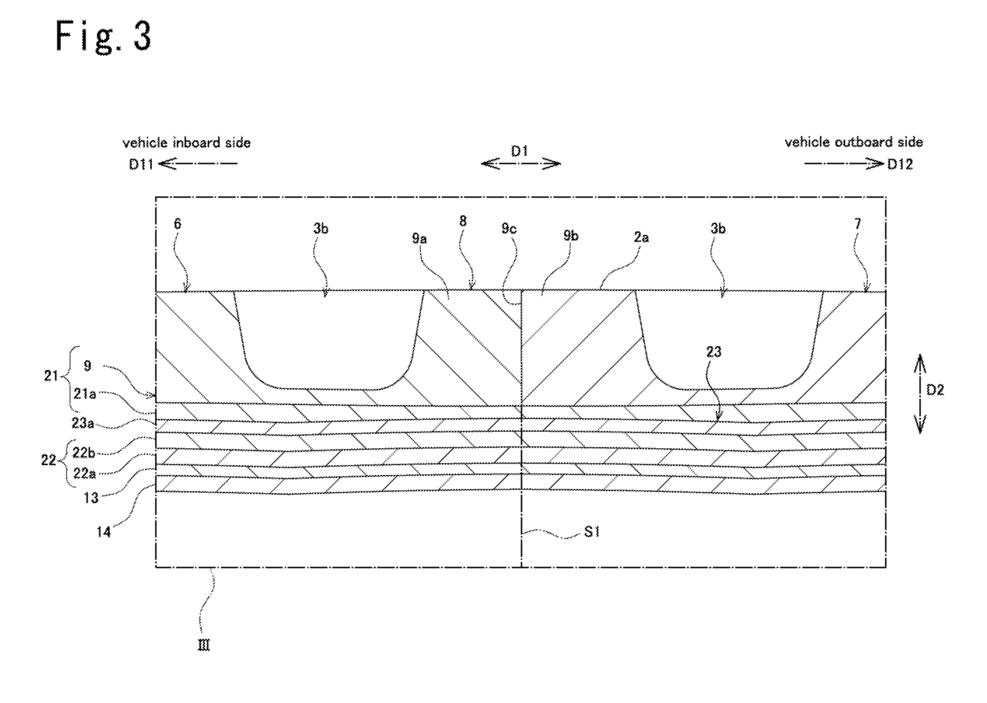

As shown in FIG. 3, tread rubber 21 is provided with rubber surface layer portion 9 having tread surface 2a which is the outer surface in the tire radial direction D2, and with rubber inner layer portion 21a which is arranged toward the interior in the tire radial direction D2 from rubber surface layer portion 9. Note that it is also possible to adopt a constitution in which rubber inner layer portion 21a is not a single layer but is two or more layers. Furthermore, that portion 21a among the rubber inner layer portion(s) 21a which is arranged inwardmost in the tire radial direction D2 is referred to as the base rubber, while rubber surface layer portion 9 and the other rubber inner layer portion(s) 21a are referred to as the cap rubber.

Rubber surface layer portion 9 is provided with first rubber portion 9a which is formed from a first rubber, and second rubber portion 9b which is formed from a second rubber, the rubber hardness of which is greater than the rubber hardness of the first rubber. Note that rubber hardness is hardness as measured at 23° C. in accordance with “JIS K 6253-1-2012 3.2 Durometer Hardness”.

While there is no particular limitation with respect to the rubber hardnesses of the respective rubbers, the rubber hardness of the first rubber might, for example, be 66 to 70; and the rubber hardness of the second rubber might, for example, be 70 to 74. Furthermore, while there is no particular limitation, for example, with respect to the difference between the rubber hardnesses of the first rubber and the second rubber, this might, for example, be 2 to 6.

Rubber surface layer portion 9 is provided with interface 9c between first rubber portion 9a and second rubber portion 9b. In addition, interface 9c is arranged between the pair of shoulder main grooves 3a, 3a. This being the case, during braking, because of the strain produced at interface 9c which is arranged between the pair of shoulder main grooves 3a, 3a, said strain will act as resistance with respect to the road surface. Accordingly, because it will be possible to reduce braking distance, it will be possible to improve performance with respect to braking.

Furthermore, in accordance with the present embodiment, so that it will be present at tread surface 2a, interface 9c is located not at main grooves 3a, 3b but at land portion 8. As a result, the strain produced at interface 9c will act as direct resistance with respect to the road surface.

Furthermore, in accordance with the present embodiment, interface 9c is located at center land portion 8; more specifically, this is located at tire equatorial plane S1. This causes it to be the case that, whereas contact patch pressure during braking is greater the nearer that one is to tire equatorial plane S1, interface 9c is located at center land portion 8 which is nearest to tire equatorial plane S1 (more specifically, this contains tire equatorial plane S1). As a result, because the strain produced at interface 9c will act as an effective resistance with respect to the road surface, it will be possible to effectively reduce braking distance.

Note that it is also possible to adopt a constitution in which, for example, interface 9c is located at main groove(s) 3a, 3b and is not present at tread surface 2a. Furthermore, it is also possible to adopt a constitution in which interface 9c, while being located at middle land portion(s) 6 through 8, is located at mediate land portion(s) 6, 7.

Furthermore, it is also possible to adopt a constitution in which interface 9c, while being located at center land portion 8, is in a location that is separated from tire equatorial plane S1. For example, it is preferred that the distance between interface 9c and tire equatorial plane S1 be not greater than 10% of the distance (dimension in the tire width direction D1) between contact patch ends 2b, 2c, more preferred that this be not greater than 5% thereof, and very much preferred that this be not greater than 3% thereof.

Furthermore, in accordance with the present embodiment, first rubber portion 9a is arranged at the first width direction side D11, and second rubber portion 9b is arranged at the second width direction side D12. That is, first rubber portion 9a is arranged at the vehicle inboard side, and second rubber portion 9b is arranged at the vehicle outboard side. As a result, it will be the case that second rubber portion 9b, at which rubber hardness is relatively high, is arranged at the vehicle outboard side, at which the area of the contact patch during turns is large. Because this will make it possible to increase rigidity at the vehicle outboard side, it will therefore make it possible to improve stability in handling during turns.

Returning to FIG. 2, in accordance with the present embodiment, the void fraction at land portions 4, 6, 8 which are made up of first rubber portion 9a is less than the void fraction at land portions 5, 7, 8 which are made up of second rubber portion 9b. As a result, it will be the case that the void fraction of land portions 4, 6, 8 which are made up of first rubber portion 9a at which rubber hardness is relatively low is less than the void fraction of land portions 5, 7, 8 which are made up of second rubber portion 9b at which rubber hardness is relatively high. Accordingly, it will be possible to suppress increase in the difference in rigidity between land portions 4, 6, 8 at first width direction side D11 and land portions 5, 7, 8 at second width direction side D12.

Note that the land portions 4, 6, 8 which are made up of first rubber portion 9a are mediate land portion(s) 6 and shoulder land portion 4 which are at the first width direction side D11 and that region within center land portion 8 which is at the first width direction side D11. Accordingly, the void fraction of land portions 4, 6, 8 which are made up of first rubber portion 9a refers to the total area of land grooves 3c, 3d as a fraction of the total area of land portions 4, 6, 8 (not including main grooves 3a, 3b but including land grooves 3c, 3d) between interface 9c and first contact patch end 2b.

Furthermore, the land portions 5, 7, 8 which are made up of second rubber portion 9b are mediate land portion(s) 7 and shoulder land portion 5 which are at the second width direction side D12 and that region within center land portion 8 which is at the second width direction side D12. Accordingly, the void fraction of land portions 5, 7, 8 which are made up of second rubber portion 9b refers to the total area of land grooves 3c, 3d as a fraction of the total area of land portions 5, 7, 8 (not including main grooves 3a, 3b but including land grooves 3c, 3d) between interface 9c and second contact patch end 2c.

Note that the pitch (spacing in the tire circumferential direction D3) of width grooves 3c at mediate land portion(s) 6 at the first width direction side D11 is greater than the pitch of width grooves 3c at mediate land portion(s) 7 at the second width direction side D12. Furthermore, the pitch of width grooves 3c (not including sipe(s) 3d) at shoulder land portion 4 at the first width direction side D11 is greater than the pitch of width grooves 3c at shoulder land portion 5 at the second width direction side D12.

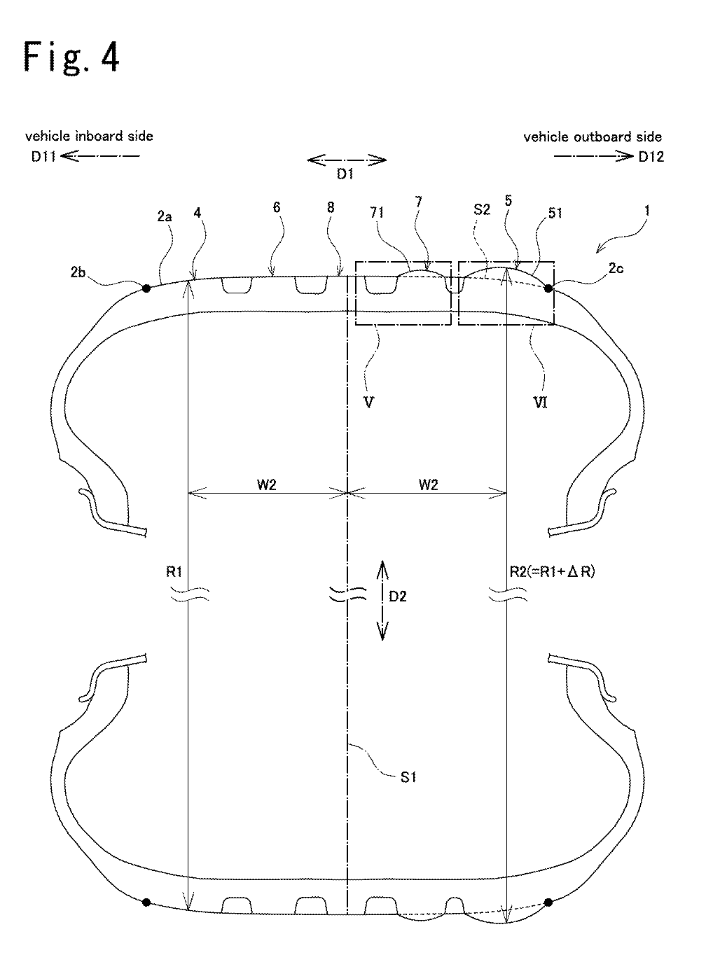

The constitutions of land portions 4 through 8 will now be described with reference to FIG. 4 through FIG. 6.

As shown in FIG. 4 through FIG. 6, profile surface S2 which serves as reference surface is present at the outer surface in the tire radial direction D2 of tread region 2. Profile surface S2 is symmetric about tire equatorial plane S1. At FIG. 4 through FIG. 6 (and the same is true for FIG. 9 et seq.), profile surface S2 is shown in broken line.

In addition, tread surface 2a to the first width direction side D11 of tire equatorial plane S1 coincides with profile surface S2. On the other hand, a portion of tread surface 2a to the second width direction side D12 of tire equatorial plane S1 is located toward the exterior in the tire radial direction D2 from profile surface S2.

That is, land portions 5, 7 to the second width direction side D12 of tire equatorial plane S1 are provided with protrusions 51, 71 which protrude toward the exterior in the tire radial direction D2 from profile surface S2. At FIG. 4 through FIG. 6 (and the same is true for FIG. 9 and FIG. 10), note that protrusions 51, 71 are drawn in exaggerated fashion.

In accordance with the present embodiment, land portions 5, 7 for which the entireties thereof are arranged to the second width direction side D12 of tire equatorial plane S1, i.e., second shoulder land portion 5 and second mediate land portion(s) 7, are provided with protrusions 51, 71. As a result, average tire outside diameter R2 to the second width direction side D12 of tire equatorial plane S1 is greater than average tire outside diameter R1 to the first width direction side D11 of tire equatorial plane S1.

Note that the amount (hereinafter also referred to as simply “protruding amount”) W1 by which protrusions 51, 71 protrude toward the exterior in the tire radial direction D2 from profile surface S2 may be calculated from the difference (hereinafter also referred to as simply “tire outside diameter difference”) ΔR (=R2−R1) between tire outside diameters R1, R2 at locations mutually separated by the same distance W2 in the tire width direction D1 from tire equatorial plane S1. More specifically, protruding amount W1 of protrusions 51, 71 is 50% of tire outside diameter difference ΔR.

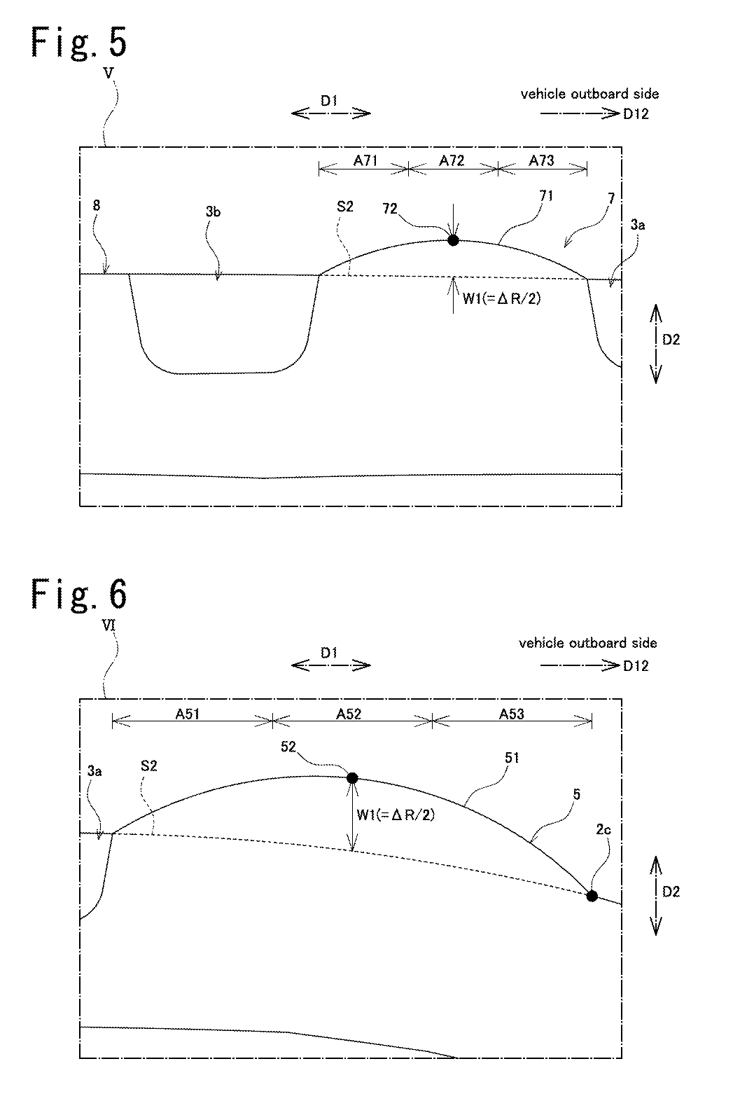

As shown in FIG. 5, second mediate land portion 7 is uniformly partitioned in the tire width direction D1 into three regions A71 through A73. In addition, from the inwardmost thereamong in the tire width direction D1, respective regions A71 through A73 are respectively referred to as inner region A71, central region A72, and outer region A73.

In addition, the location at tread surface 2a at which the protruding amount of protrusion 71 of second mediate land portion 7 is a maximum, i.e., peak 72 of protrusion 71, is arranged within central region A72 of second mediate land portion 7. Moreover, in accordance with the present embodiment, that portion of second mediate land portion 7 which is the location at tread surface 2a at which tire outside diameter difference ΔR is a maximum is peak 72 of protrusion 71.

As shown in FIG. 6, second shoulder land portion 5 is uniformly partitioned in the tire width direction D1 into three regions A51 through A53. In addition, from the inwardmost thereamong in the tire width direction D1, respective regions A51 through A53 are respectively referred to as inner region A51, central region A52, and outer region A53.

In addition, the location at tread surface 2a at which the protruding amount of protrusion 51 of second shoulder land portion 5 is a maximum, i.e., peak 52 of protrusion 51, is arranged within central region A52 of second shoulder land portion 5. Moreover, in accordance with the present embodiment, that portion of second shoulder land portion 5 which is the location at tread surface 2a at which tire outside diameter difference ΔR is a maximum is peak 52 of protrusion 51.

It so happens that, whereas central regions A52, A72 of land portions 5, 7 tend not to come in contact with the road surface, peaks 52, 72 of protrusions 51, 71 are arranged at central regions A52, A72 of land portions 5, 7. As a result, it is possible for land portions 5, 7 to come in contact with the ground at all locations thereof in the tire width direction D1.

Furthermore, as shown in FIG. 5 and FIG. 6, the average tire outside diameter difference ΔR at second shoulder land portion 5 is greater than the average tire outside diameter difference ΔR at second mediate land portion 7. In addition, the maximum tire outside diameter difference ΔR at second shoulder land portion 5 is greater than the maximum tire outside diameter difference ΔR at second mediate land portion 7.

That is, the maximum protruding amount W1 of protrusion 51 at second shoulder land portion 5 is greater than the maximum protruding amount W1 of protrusion 71 at second mediate land portion 7. Moreover, while there is no particular limitation with respect, to the maximum protruding amounts W1 of protrusions 51, 71, these might, for example, be 1% to 3% of the depth of shoulder main groove 3a.

Constitution of pneumatic tire 1 associated with the present embodiment is as described above; action of pneumatic tire 1 associated with the present embodiment is described below.

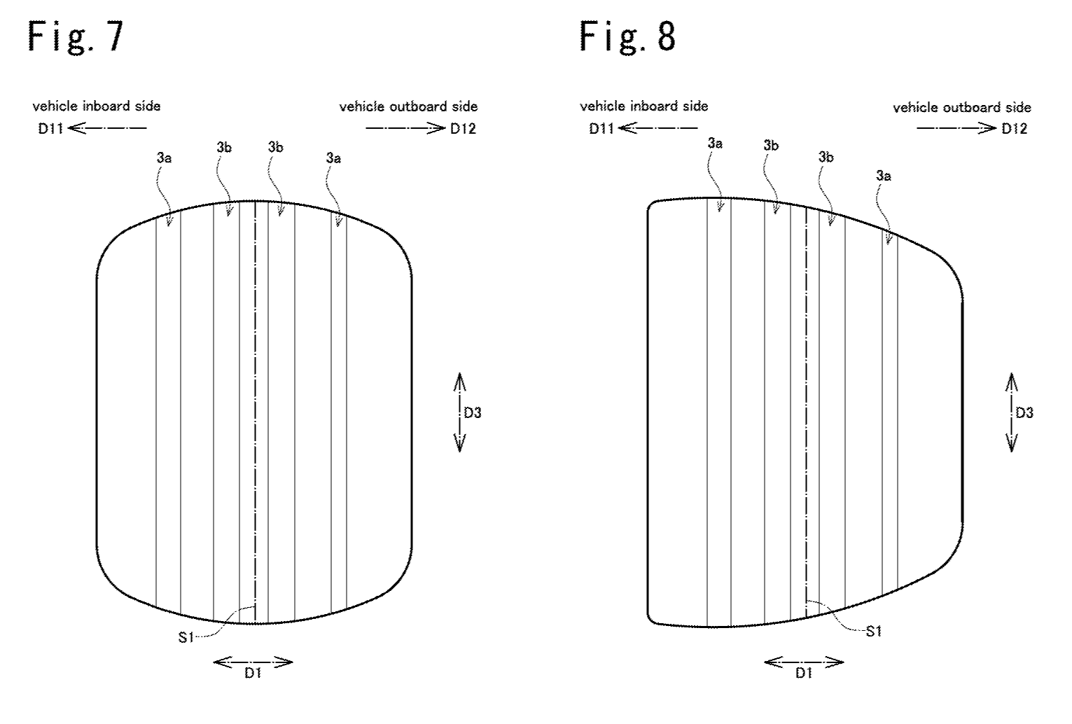

For example, FIG. 7 shows the shape of the contact patch at a tire associated with a comparative embodiment (note that land grooves 3c, 3d are not shown at FIG. 7 (and the same is true for FIG. 8)). Moreover, the tire associated with the comparative example is such that, as compared with tire 1 associated with the present embodiment, tread surface 2a is symmetric about tire equatorial plane S1, which is to say that this is a tire in which the constitution has been changed such that, at all locations thereof in the tire width direction D1, there is no tire outside diameter difference ΔR.

In addition, at the tire associated with the comparative example, because first rubber portion 9a, at which rubber hardness is relatively low, is arranged at the first width direction side D11, contact patch length (length in the tire circumferential direction D3 of the contact patch shape) at the first width direction side D11 is greater than contact patch length at the second width direction side D12. As a result, because the difference between the contact patch length at the first width direction side D11 and the contact patch length at the second width direction side D12 is large, the amount of conicity (force which acts so as to be directed toward the first width direction side D11) that occurs when driving straight ahead will be large.

To address this, tire 1 in accordance with the present embodiment is such that average tire outside diameter R2 to the second width direction side D12 of tire equatorial plane S1 is greater than average tire outside diameter R1 to the first, width direction side D11 of tire equatorial plane S1. As a result, based only upon consideration of tire outside diameters R1, R2, contact patch length at the second width direction side D12 will be greater than contact patch length at the first width direction side D11.

Accordingly, as shown in FIG. 8, it is possible to suppress occurrence of a difference between the contact patch length at the first width direction side D11 and the contact patch length at the second width direction side D12. It will therefore be possible to suppress increase in the amount of conicity that might otherwise occur when driving straight ahead.

And, to address the fact that there is a tendency for the difference between the contact patch lengths at the pair of shoulder land portions 4, 5 to increase, the average tire outside diameter difference ΔR at second shoulder land portion 5 is made greater than the average tire outside diameter difference ΔR at second mediate land portion 7. As a result, it will be possible to effectively suppress increase in the difference between the contact patch lengths at the pair of shoulder land portions 4, 5.

As described above, pneumatic tire 1 of the embodiment includes a plurality of main grooves 3a, 3b extending in a tire circumferential direction D3, the pneumatic tire 1 includes: a rubber surface layer portion 9 having an outer surface in a tire radial direction D2; the rubber surface layer portion 9 comprises a first rubber portion 9a formed from a first rubber, and a second rubber portion 9b formed from a second rubber having a rubber hardness greater than a rubber hardness of the first rubber; the first rubber portion 9a is arranged at a first side D11 in a tire width direction D1; the second rubber portion 9b is arranged at a second side D12 in the tire width direction D1; an interface 9c between the first rubber portion 9a and the second rubber portion 9b is arranged between a pair of main grooves 3a, 3a that are arranged in outwardmost fashion in the tire width direction D1; and an average tire outside diameter R2 toward the second side D12 in the tire width direction D1 from a tire equatorial plane S1 is greater than an average tire outside diameter R1 toward the first side D11 in the tire width direction D1 from the tire equatorial plane S1.

In accordance with such constitution, strain will be produced at interface 9c between first rubber portion 9a and second rubber portion 9b during braking. In addition, because interface 9c is arranged between the pair of main grooves 3a, 3a that are arranged in outwardmost fashion in the tire width direction D1, said strain will act as resistance with respect to the road surface. Accordingly, because it will be possible to reduce braking distance, it will be possible to improve performance with respect to braking.

In addition, whereas first rubber portion 9a, at which rubber hardness is relatively low, is arranged at the first side D11 in the tire width direction D1, average tire outside diameter R2 toward the second side D12 in the tire width direction D1 from tire equatorial plane S1 is greater than average tire outside diameter R1 toward the first side D11 in the tire width direction D1 from tire equatorial plane S1. As a result, it will be possible to suppress occurrence of a difference in contact patch lengths at the first side D11 versus the second side D12 in the tire width direction D1 when driving straight ahead.

Further, the pneumatic tire 1 of the embodiment further includes a plurality of land portions 4 through 8 that are partitioned by contact patch ends 2b, 2c and the plurality of main grooves 3a, 3b; wherein the plurality of land portions 4 through 8 include a shoulder land portion 5 that is arranged toward the second side D12 in the tire width direction D1 from the tire equatorial plane S1 and that is arranged in outwardmost fashion at the second side D12 in the tire width direction D1, and a middle land portion 7 that is arranged toward the second side D12 in the tire width direction D1 from the tire equatorial plane S1 and that is arranged in next-to-outwardmost fashion at the second side D12 in the tire width direction D1; and an average tire outside diameter difference ΔR between locations mutually separated by identical amounts in the tire width direction D1 from the tire equatorial plane S1 at the shoulder land portion 5 is greater than an average tire outside diameter difference ΔR between locations mutually separated by identical amounts in the tire width direction D1 from the tire equatorial plane S1 at the middle land portion 7.

In accordance with such constitution, to address the fact that there is a tendency for the difference between the contact patch lengths at the pair of shoulder land portions 4, 5 to increase, the average tire outside diameter difference ΔR between locations mutually separated by identical amounts in the tire width direction D1 from tire equatorial plane S1 at shoulder land portion 5 arranged at the outwardmost location at the second side D12 in the tire width direction D1 is greater than said average tire outside diameter difference ΔR at middle land portion 7 arranged in next-to-outwardmost fashion at the second side D12 in the tire width direction D1. As a result, it will be possible to suppress increase in the difference between the contact patch lengths at the pair of shoulder land portions 4, 5.

Further, the pneumatic tire 1 of the embodiment further includes an indicator region that indicates a vehicle mounting direction; wherein the second rubber portion 9b is arranged toward the exterior when the tire is mounted on the vehicle.

In accordance with such constitution, to address the fact that contact patch area in region(s) toward the exterior when the tire is mounted on the vehicle will be large during turns, second rubber portion 9b, at which rubber hardness is relatively high, is arranged toward the exterior when the tire is mounted on the vehicle. Because this will make it possible to increase rigidity in region(s) toward the exterior when the tire is mounted on the vehicle, it will be possible to improve stability in handling during turns.

Further, the pneumatic tire 1 of the embodiment further includes a plurality of land portions 4 through 8 that are partitioned by contact patch ends 2b, 2c and the plurality of main grooves 3a, 3b; wherein a void fraction of those 4, 6, 8 among the land portions 4 through 8 that are made up of the first rubber portion 9a is less than a void fraction of those 5, 7, 8 among the land portions 4 through 8 that are made up of the second rubber portion 9b.

In accordance with such constitution, the void fraction of land portions 4, 6, 8 which are made up of first rubber portion 9a at which rubber hardness is relatively low is less than the void fraction of land portions 5, 7, 8 which are made up of second rubber portion 9b at which rubber hardness is relatively high. As a result, it will be possible to suppress increase in differences in rigidity at land portions 4, 6, 8 at the first side D11 in the tire width direction D1 and land portions 5, 7, 8 at the second side D12 therein.

Further, the pneumatic tire 1 of the embodiment further includes a center land portion (8) that is partitioned by the plurality of main grooves 3a, 3b, the center land portion 8 that contains the tire equatorial plane (S1); wherein the interface 9c is located at the center land portion 8.

In accordance with such constitution, because interface 9c is located at center land portion 8, the strain produced at interface 9c will act as direct resistance with respect to the road surface. Moreover, whereas contact patch pressure during braking is greater the nearer that one is to tire equatorial plane S1, because interface 9c is located at center land portion 8 which is nearest to tire equatorial plane S1, strain produced at interface 9c will act as an effective resistance with respect to the road surface.

The pneumatic tire 1 is not limited to the configuration of the embodiment described above, and the effects are not limited to those described above. It goes without saying that the pneumatic tire 1 can be variously modified without departing from the scope of the subject matter of the present invention. For example, the constituents, methods, and the like of various modified examples described below may be arbitrarily selected and employed as the constituents, methods, and the like of the embodiments described above, as a matter of course.

(1) The constitution of pneumatic tire 1 associated with the foregoing embodiment is such that peaks 52, 72 of protrusions 51, 71 are arranged at central regions A52, A72 of land portions 5, 7. However, pneumatic tire 1 is not limited to such constitution. For example, it is also possible to adopt a constitution in which peaks 52, 72 of protrusions 51, 71 are arranged at inner regions A51, A71 of land portions 5, 7

Furthermore, for example as shown in FIG. 9, it is also possible to adopt a constitution in which peak 52 of protrusion 51 is arranged at outer region A53 of land portion 5. In accordance with such constitution, whereas there is a tendency for the difference in contact patch lengths to be greater the further one is toward the exterior in the tire width direction D1, it is possible to effectively suppress increase in the difference between said contact patch lengths.

(2) Furthermore, the constitution of pneumatic tire 1 associated with the foregoing embodiment is such that protrusions 51, 71 are provided with peaks 52, 72. However, pneumatic tire 1 is not limited to such constitution. For example, as shown in FIG. 10, it is also possible to adopt a constitution in which the amount by which protrusion 51 protrudes from profile surface S2 is the same at all locations in the tire width direction D1 of land portion 5, which is to say that protrusion 51 is not provided with peak 52.

(3) Furthermore, the constitution of pneumatic tire 1 associated with the foregoing embodiment is such that protrusions 51, 71 are provided only at land portions 5, 7 arranged to the second width direction side D12 of tire equatorial plane S1. However, pneumatic tire 1 is not limited to such constitution. For example, it is also possible to adopt a constitution in which protrusions are also provided at land portions 4, 6, 8 arranged to the first width direction side D11 of tire equatorial plane S1.

(4) Furthermore, the constitution of pneumatic tire 1 associated with the foregoing embodiment is such that the average tire outside diameter difference ΔR at second shoulder land portion 5 is greater than the average tire outside diameter difference ΔR at middle land portion 7 adjacent to second shoulder land portion 5. However, while such constitution is preferred, pneumatic tire 1 is not limited to such constitution. It is also possible to adopt a constitution in which, for example, the average tire outside diameter difference ΔR at second shoulder land portion 5 is the same as the average tire outside diameter difference ΔR at said middle land portion 7, and it is also possible to adopt a constitution in which, for example, this is less than the average tire outside diameter difference ΔR at said middle land portion 7.

(5) Furthermore, the constitution of pneumatic tire 1 associated with the foregoing embodiment is such that the maximum tire outside diameter difference ΔR at second shoulder land portion 5 is greater than the maximum tire outside diameter difference ΔR at middle land portion 7 adjacent to second shoulder land portion 5. However, while such constitution is preferred, pneumatic tire 1 is not limited to such constitution. It is also possible, for example, to adopt a constitution in which the maximum tire outside diameter difference ΔR at second shoulder land portion 5 is the same as the maximum tire outside diameter difference ΔR at said middle land portion 7, and it is also possible, for example, to adopt a constitution in which this is less than the maximum tire outside diameter difference ΔR at said middle land portion 7.

(6) Furthermore, the constitution of pneumatic tire 1 associated with the foregoing embodiment is such that second rubber portion 9b is arranged toward the exterior when the tire is mounted on the vehicle. However, while such constitution is preferred, pneumatic tire 1 is not limited to such constitution. For example, it is also possible to adopt a constitution in which second rubber portion 9b is arranged toward the interior when the tire is mounted on the vehicle.

(7) Furthermore, the constitution of pneumatic tire 1 associated with the foregoing embodiment is such that the void fraction of land portions 4, 6, 8 which are made up of first rubber portion 9a is less than the void fraction of land portions 5, 7, 8 which are made up of second rubber portion 9b. However, while such constitution is preferred, pneumatic tire 1 is not limited to such constitution.

It is also possible, for example, to adopt a constitution in which the void fraction of land portions 4, 6, 8 which are made up of first rubber portion 9a is the same as the void fraction of land portions 5, 7, 8 which are made up of second rubber portion 9b, and it is also possible, for example, to adopt a constitution in which the void fraction of land portions 4, 6, 8 which are made up of first rubber portion 9a is greater than the void fraction of land portions 5, 7, 8 which are made up of second rubber portion 9b.

(8) Furthermore, the constitution of pneumatic tire 1 associated with the foregoing embodiment is such that this is a tire for which a vehicle mounting direction is indicated. However, pneumatic tire 1 is not limited to such constitution. For example, it is also possible to adopt a constitution in which pneumatic tire 1 is a tire for which a vehicle mounting direction is not indicated. In accordance with such constitution, the tread pattern will be a shape that exhibits point symmetry about an arbitrary point on the tire equator, or will be a shape that exhibits line symmetry about the tire equator.

1. A pneumatic tire comprising a plurality of main grooves extending in a tire circumferential direction, the pneumatic tire comprising:
a rubber surface layer portion having an outer surface in a tire radial direction;
the rubber surface layer portion comprises a first rubber portion formed from a first rubber, and a second rubber portion formed from a second rubber having a rubber hardness greater than a rubber hardness of the first rubber;
the first rubber portion is arranged at a first side in a tire width direction;
the second rubber portion is arranged at a second side in the tire width direction;
an interface between the first rubber portion and the second rubber portion is arranged between a pair of main grooves that are arranged in outwardmost fashion in the tire width direction; and
an average tire outside diameter toward the second side in the tire width direction from a tire equatorial plane is greater than an average tire outside diameter toward the first side in the tire width direction from the tire equatorial plane.

2. The pneumatic tire according to claim 1, further comprising a plurality of land portions that are partitioned by contact patch ends and the plurality of main grooves;
wherein the plurality of land portions include a shoulder land portion that is arranged toward the second side in the tire width direction from the tire equatorial plane and that is arranged in outwardmost fashion at the second side in the tire width direction, and a middle land portion that is arranged toward the second side in the tire width direction from the tire equatorial plane and that is arranged in next-to-outwardmost fashion at the second side in the tire width direction; and
an average tire outside diameter difference between locations mutually separated by identical amounts in the tire width direction from the tire equatorial plane at the shoulder land portion is greater than an average tire outside diameter difference between locations mutually separated by identical amounts in the tire width direction from the tire equatorial plane at the middle land portion.

3. The pneumatic tire according to claim 1, further comprising a plurality of land portions that are partitioned by contact patch ends and the plurality of main grooves;
wherein the plurality of land portions include a shoulder land portion that is arranged toward the second side in the tire width direction from the tire equatorial plane and that is arranged in outwardmost fashion at the second side in the tire width direction, and a middle land portion that is arranged toward the second side in the tire width direction from the tire equatorial plane and that is arranged in next-to-outwardmost fashion at the second side in the tire width direction; and
a maximum tire outside diameter difference between locations mutually separated by identical amounts in the tire width direction from the tire equatorial plane at the shoulder land portion is greater than a maximum tire outside diameter difference between locations mutually separated by identical amounts in the tire width direction from the tire equatorial plane at the middle land portion.

4. The pneumatic tire according to claim 1, further comprising an indicator region that indicates a vehicle mounting direction;
wherein the second rubber portion is arranged toward the exterior when the tire is mounted on the vehicle.

5. The pneumatic tire according to claim 1, further comprising a plurality of land portions that are partitioned by contact patch ends and the plurality of main grooves;
wherein a void fraction of those among the land portions that are made up of the first rubber portion is less than a void fraction of those among the land portions that are made up of the second rubber portion.

6. The pneumatic tire according to claim 1, further comprising a center land portion that is partitioned by the plurality of main grooves, the center land portion that contains the tire equatorial plane;
wherein the interface is located at the center land portion.

7. The pneumatic tire according to claim 1, further comprising a plurality of land portions that are partitioned by contact patch ends and the plurality of main grooves;
wherein the plurality of land portions include a first shoulder land portion that is arranged in outwardmost fashion at the first side in the tire width direction, and a second shoulder land portion that is arranged in outwardmost fashion at the second side in the tire width direction;
the respective first and second shoulder land portions are provided with a plurality of width grooves of groove width not less than 1.6 mm, the width grooves extend so as to intersect the tire circumferential direction; and
pitch between the width grooves at the first shoulder land portion is greater than pitch between the width grooves at the second shoulder land portion.

8. The pneumatic tire according to claim 1, further comprising a plurality of land portions that are partitioned by contact patch ends and the plurality of main grooves;
wherein the plurality of land portions include a shoulder land portion that is arranged in outwardmost fashion at the second side in the tire width direction;
the shoulder land portion is provided with a protrusion that protrudes toward the exterior in the tire radial direction from a profile surface;
the shoulder land portion is uniformly partitioned in the tire width direction into three regions including a central region; and
a peak of the protrusion is arranged at the central region.

9. The pneumatic tire according to claim 1, further comprising a plurality of land portions that are partitioned by contact patch ends and the plurality of main grooves;
wherein the plurality of land portions include a shoulder land portion that is arranged in outwardmost fashion at the second side in the tire width direction;
the shoulder land portion is provided with a protrusion that protrudes toward the exterior in the tire radial direction from a profile surface;
the shoulder land portion is uniformly partitioned in the tire width direction into three regions; and
a peak of the protrusion is arranged at that region among the three regions which is most toward the second side in the tire width direction.
